(19) United States
(12) Patent Application Publication
(10) Pub. No.: US 2010/0299287 A1
(43) Pub. Date: Nov. 25, 2010

(54) Monitoring time-varying network streams using state-space models

(75) Inventors: Jin Cao, Edison, NJ (US); Aiyou Chen, New Providence, NJ (US); Tian Bu, Basking Ridge, NJ (US)

Correspondence Address: HARNESS, DICKEY & PIERCE, P.L.C., P.O. BOX 8910, RESTON, VA, 20195, US

(73) Assignee: Alcatel-Lucent USA Inc.

(21) Appl. No.: 12/453,815

(22) Filed: May 22, 2009

(51) Int. Cl. G06F 15/18; G06F 17/10; G06F 11/00; G06F 17/14; G06N 5/02

(52) U.S. Cl. 706/12; 708/320; 703/2; 714/704; 708/400; 706/47; 714/E11.004

(57) ABSTRACT

In one embodiment, a statistical model is generated based on observed data, the observed data being associated with a network device, online parameter fitting is performed on parameters of the statistical model, and for each newly observed data value, a forecast value is generated based on the statistical model, the forecast value being a prediction of a next observed data value, a forecasting error is generated based on the forecast value and the newly observed data value, and whether the data of the network stream is abnormal is determined based on a log likelihood ratio test of the forecasting errors and a threshold value.

### BACKGROUND OF THE INVENTION

1. Field

Example embodiments of the present invention relate generally to methods of detecting anomalous events in a time-varying cyclical network series associated with elements in a network.

2. Description of Related Art

Many network management protocol systems rely on reporting aggregate network statistics at regular intervals. Abnormal values of these statistics may signal a network problem. For example, unusually large values of packet/byte counts on a network element may signal a denial of service attack in progress, and large values of average network latencies may signal an overloaded network.

A simple method for detecting abnormal values in these network statistics is to use thresholds. However, a simple fixed threshold often does not work well when the network statistics exhibit daily or weekly patterns or long-term trends.

For example, data relating to a number of attempted connections at a base station in an EVDO network observed at every five minute interval for the first eight days of a two week period may exhibit daily patterns that are different for weekdays and weekends. Given such data, a fixed threshold for detecting abnormal values is inappropriate since what is considered normal for the busy hours may be abnormal for non-busy periods.

### SUMMARY OF THE INVENTION

The present invention relates to methods of modeling and detecting abnormalities in data of a network stream.

In one embodiment, a statistical model is generated based on observed data, the observed data being associated with a network device. For each newly observed data value, online parameter fitting is performed on parameters of the statistical model. A forecast value is generated based on the statistical model, the forecast value being a prediction of a next observed data value; a forecasting error is generated based on the forecast value and the newly observed data value; and whether the data of the network stream is abnormal is determined based on a log likelihood ratio of the forecasting error and a threshold value.

In another embodiment, an apparatus for modeling and detecting abnormalities in data of a network stream includes a memory and a processor. The memory stores parameters and data values associated with the network stream. The processor is coupled to the memory and configured to control operations associated with modeling and detecting abnormalities in the data of the network stream.

The operations include generating a statistical model based on observed data, the observed data being associated with the apparatus. The operations further include, for each newly observed data value, performing online parameter fitting on parameters of the statistical model; generating a forecast value based on the statistical model, the forecast value being a prediction of a next observed data value; generating a forecasting error based on the forecast value and the newly observed data value; and determining whether the data of the network stream is abnormal based on a log likelihood ratio of the forecasting error and a threshold value.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1 is a diagram illustrating an exemplary network system.

FIG. 2 is a flow chart illustrating an exemplary method of modeling and detecting abnormalities in data of a network stream.

FIG. 3 is an exemplary graph illustrating a number of attempted connections at a base station, in square root scale, observed at every 5 minute interval, for the first 8 days of a two week period.

FIG. 4 is a cyclical cubic spline basis on equally spaced knots every 3 hours.

FIG. 5A illustrates an exemplary graph of the fit for the square root of the number of attempted calls for the first day in the graph illustrated in FIG. 3, using the same cyclical spline basis illustrated in FIG. 4.

FIG. 5B illustrates an exemplary quantile-quantile plot of residuals from the fit illustrated in FIG. 5A.

FIG. 5C illustrates an exemplary graph plotting the residuals of the fit illustrated in FIG. 5A against a fitted mean.

FIG. 6A illustrates an exemplary graph showing a time series plot of a number of attempted connections for a base station in the EVDO network, in square root scale.

FIG. 6B illustrates an exemplary graph showing experimental results of a exponentially weighted moving averages (EWMA) monitoring scheme applied to the data illustrated in FIG. 6A.

FIG. 6C illustrates an exemplary graph showing experimental results of a CUMSUM monitoring scheme applied to the data illustrated in FIG. 6A.

### DETAILED DESCRIPTION OF EXAMPLE EMBODIMENTS

Various example embodiments of the present invention will now be described more fully with reference to the accompanying drawings in which some example embodiments of the invention are shown.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term access terminal (AT) may be considered synonymous to, and may hereafter be occasionally referred to, as a terminal, mobile unit, mobile station, mobile user, user equipment (UE), subscriber, user, remote station, access terminal, receiver, etc., and may describe a remote user of wireless resources in a wireless communication network. The term base station may be considered synonymous to and/or referred to as a base transceiver station (BTS), NodeB, extended Node B, femto cell, access point, etc. and may describe equipment that provides the radio baseband functions for data and/or voice connectivity between a network and one or more users.

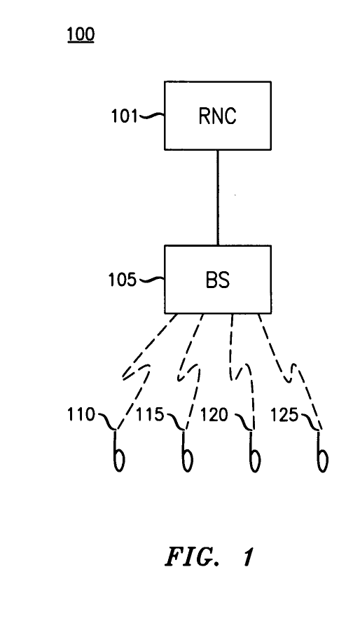

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types. The program modules and functional processes discussed herein may be implemented using existing hardware in existing communication networks. For example, program modules and functional processes discussed herein may be implemented using existing hardware at existing network elements or control nodes (e.g., an RNC or base station shown in FIG. 1). Such existing hardware may include one or more digital signal processors (DSPs), application-specific-integrated-circuits, field programmable gate arrays (FPGAs) computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

FIG. 1 illustrates a portion of an exemplary network 100. Referring to FIG. 1, a wireless network 100 includes a radio network controller (RNC) 101, and a base station (BS) 105, and a plurality of mobile devices 110-125. The wireless network 100 may have multiple BSs communicating with one RNC, however, only one of is shown for clarity. Further, the wireless network 100 may have multiple RNCs, however, only one of is shown for clarity. The BS 105 is connected to the RNC 101 and the mobile devices 110-125, each of which may communicate wirelessly with the BS 105. Though, for the purpose of clarity, only four mobile devices are illustrated, any number of mobile devices may periodically attempt to connect to BS 105.

Both the RNC 101 and the BS 105 may include monitoring software and/or hardware capable of monitoring network statistics over time including, for example, a processor and a memory. The network statistics monitored by the BS 105 may include, for example, a number of connection attempts to the BS 105 made by mobile devices, such as the mobile devices 110-125, over given time intervals. The network statistics monitored by the RNC 101 may include, for example, average network latencies of wireless calls handled by the RNC 101 over given time intervals.

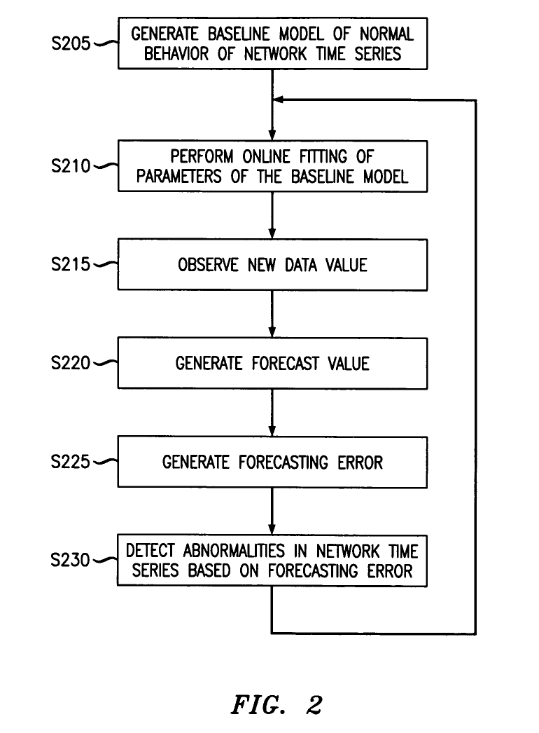

The monitoring programs and/or hardware included in the BS 105 and/or the RNC 101 are capable of establishing normal behavior of the monitored statistics and detecting abnormalities or departures from normal behavior in the monitored network statistics following a monitoring method explained further below with respect to FIG. 2.

### Overview of Monitoring Method

FIG. 2 illustrates a flow chart of an exemplary method for modeling and detecting abnormalities in data of a network stream. The method in FIG. 2 will be explained with reference to network statistics monitored by the BS 105. For example, the network statistics monitored by the BS 105 may be the numbers of connection attempts made to the BS 105 over a plurality of time intervals, for example within every 5 minute time interval. Below, the network statistics monitored by the BS 105 will be explained in terms of a function y(t). Let y(t) be the network time series under study.

In the following discussion, a simplified assumption is made that under a known transformation g(·), the transformed data, g(y(t)), is Gaussian with a constant variance. This simplifying Gaussian assumption works well for many network statistics, as many statistics are typically collected at regular time intervals and represent an average value for the duration of the interval. If the aggregation is significant, the coefficient of variations of the statistic of g(y(t)), defined by the ratios of variances with respect to means squared, are small. Hence, transformations of the statistics are also approximately Gaussian. The constant variance is typically achieved by a variance stabilization transform, which is a known technique in statistics.

Embodiments of the monitoring method for monitoring y(t) include the following two main components, 1) a baseline state-space model for the normal activity, which is explained with reference to steps S205-S210 in FIG. 2; and 2) likelihood ratio based monitoring using forecasting errors, which is explained with reference to steps S215-S230.

In step S205, a baseline model representing the normal behavior of g(y(t)) is generated. The mean of g(y(t)) is modeled by B-spline functions to capture the time (e.g., daily, weekly) patterns, and then the change in the time patterns are modeled using a random walk model of the spline parameters.

In step S210, online parameter fitting is performed for the baseline model generated in step S205. For online parameter fitting, a modified form of the original state space model generated in step S205 is used and the well known Kalman Filter algorithm is applied. As will be discussed in further detail later in conjunction with step S210, the modified model tracks the network time series under study, y(t), in terms of individual time periods t, for example data collected every, for example, 5 minutes, as opposed to daily cycles. Accordingly, instead of updating parameters of the state space model after each daily cycle, parameters of the modified model can be updated after each time period t. The variability of time patterns is learned automatically from data, using method of moments which is computationally light. Therefore, if the patterns are very stable, the variance will be small, and vise versa. Accordingly, the baseline time behavior of the network time series can be established solely from the data.

Steps S210-S230 are performed for each observed data value. An observed data value is an aggregate of network statistics observed in an interval of time. For example, an observed data value may be a total number of attempted connections at BS 105 over a five minute time period.

In step S215, a new data value is observed. In step S230 the baseline model generated in S205, which was modified by the online Kalman fitting algorithm in step S210, generates a forecasting value. The forecasting value is a prediction of a future data value.

In step S225, a forecasting error is calculated based on the difference between the forecasting value generated in step S220, and an actual observed data value. Since the random walk model of the time patterns (e.g., daily/weekly) creates correlations between successive network observations, to monitor departures from the baseline model, online monitoring schemes are used. The online monitoring schemes are based on the forecasting errors computed from the baseline model, which are shown to be independent of each other.

In S230, using the online monitoring schemes, abnormalities in the monitored network statistics are detected based on sequential likelihood ratio test of the forecasting error generated in step S225, and previously generated forecasting errors. The likelihood ratio test for statistical change detection may be approximated using a CUMSUM method. The CUMSUM method may include calculating a cumulative sum of values based on the log likelihood ratios of past and present forecasting errors. Steps S205-S230 are each discussed in greater detail below.

### Common Notations

In the following discussion, f(·) is to represent the probability density function, E(·) and Var(·) to represent the expectation and variance of a random variable, and Cov(·,·) to represent the covariance between two random variables. Further, x₊ is used to represent the maximum of x and 0, f′(x) is used to represent the derivative of f, i.i.d. is used to stand for independent and identically distributed (for random variables), and N(μ, σ) to represent a Gaussian distribution with a mean μ and variance σ². Other common notations are listed below in Table 1. Further, knots are points where piece-wise functions that make up a B-spline function connect to ensure continuity and smoothness.

TABLE 1

| | |
|---|---|
| y(t) | network series being monitored with time index t |
| zₜ = g(y(t)) | network series transformed so that zₜ is Gaussian with |
| | constant variance |
| Y_{c}, c | cth daily cycle of y(t); c is the cycle index |
| K | number of knots for the spline function |
| L | length of the daily cycle |
| εₜ, nₜ | standardized random noises in state and observation |
| | equations |
| σ², ν | variance parameter of random noises in state and |
| | observation equations |
| zₜ*, rₜ*, * | forecasting value and error, * represents forecasting |

### Generating the Baseline Model

The process by which the baseline model of network time series y(t) is generated in step S205 will now be discussed in greater detail. The baseline model generated in step S205 is a state-space model.

The state-space model or dynamic linear model was first introduced as a mathematical model of a physical system of a set of input, output and state variables related by first-order differential equations.

In its basic form, the state-space model consists of two equations, a state equation, representing how the unobserved state xₜ [a p×1 vector) of a control system changes from past state xₜ₋ᵢ,

xₜ=φxₜ₋₁+εₜ (1)

where ε t are i.i.d. Gaussian random variables with a p×p covariance matrix Qₜ, and a observation equation that represents the relationship between the system observations zₜ (a q×1 vector) and the unobservable state vector xₜ,

zₜ=Aₜxₜ+nₜ, (2)

where nₜ is assumed to be i.i.d. Gaussian random variable with a q×q covariance matrix Rₜ. In its basic form, it is also assumed that the white noise series {εₜ} and {nₜ} are independent. However, this can be generalized to allow {εₜ} and {nₜ} that are correlated only at time t; that is Cov(εₜ, nₜ)=Sₜ, and 0 otherwise.

The baseline reference model for the monitored network time series y(t) is established in its normal state in the state-space form explained above with reference to equations (1) and (2). For the purpose of simplicity, it is assumed that there are only daily patterns in y(t), where observed network statistics vary according to the time of day. Day-of-the-week patterns y(t), where network statistics may additionally vary according to which day of the week it is, will be discussed further below.

Daily patterns in the monitored network time series y(t) are captured using a spline function. It is known that every spline function of a given degree d, can be represented as a linear combination of orthogonal B-spline basis functions. It also known that the B-spline basis function for equally spaced knots are shifted copies of the same function.

Due to the daily cyclical nature of network series y(t), it may be required that the spline basis be cyclic such that hour 0 is the same as hour 24. For a given number of K equally spaced knots, it can be shown that there are altogether K−1 cyclical B-spline basis functions. Furthermore, these cyclical B-splines can be constructed from the original basis function by shifting and wrapping around at the hour 0.

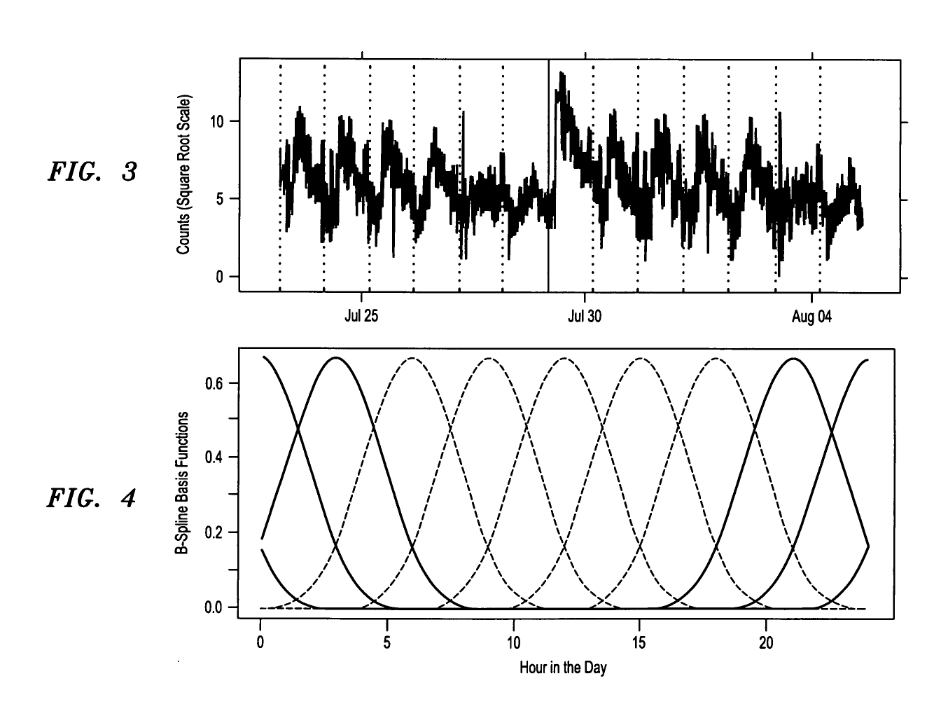

Exemplary FIG. 4 demonstrates the cyclical daily cubic spline basis functions (degree 3), with 9 equally spaced knots occurring every 3 hours at hour 0, 3, . . . , 21. Highlighted in FIG. 4, are three cyclical spline basis functions that are non-zero at the boundaries (each of which is denoted by a dark, unbroken line). In fact, without the cyclical requirement, the B-spline basis functions defined on the interval [0, 24] with the same 9 knots would include 11 functions.

Suppose the monitoring software and/or hardware in the BTS 105 observes time series y(t) at regularly spaced times. Let L be the number of observations during a single day, and let Y, =(y_{c. 1}, . . . , y_{c,L}) represent the cth daily cycle of y(t). It is assumed that under a known transformation g(·), the transformed data, g(Y_{c}), is Gaussian with a mean that can be modeled by a smooth spline function,

$$g ( Yc ) = A {\tilde{α}}_{c} + {v}^{\frac{1}{2}} {\tilde{n}}_{c} \\ ( observation equation ) \qquad ( 3 )$$

where A is the L×K matrix representing the cyclic B-spline basis at the given K grid points, ã_{c} is the unknown spline parameters, vis the common variance of the observational noise, and ñ_{c} is the Gaussian vector with variance 1.

The Gaussianization and variance stabilization as a result of transformation g is a common technique used in statistics to make the statistical inference more tractable. Although it is very possible that no transformation function g can satisfy such a requirement, when the monitored statistics y(t) represents aggregate statistics for the duration of an equally spaced interval, as is often the case, it is very likely that a transformation function g can be found approximately. This is because when the aggregation in the interval is significant, the coefficient of variation of the statistic y(t), defined by the ratio of the variance of y(t) with respect to the mean squared, is small. Hence any monotone transformation of the statistic is also approximately Gaussian. The constant variance of g(y(t)) is then achieved by a specific transformation, using a common technique in statistics called variance stabilization transforms.

An example of the spline model discussed above will now be discussed with reference to FIGS. 3, 4 and 5. FIG. 3 illustrates an example of a number of attempted connections at the BS 105, in square root scale, observed at every five minute interval.

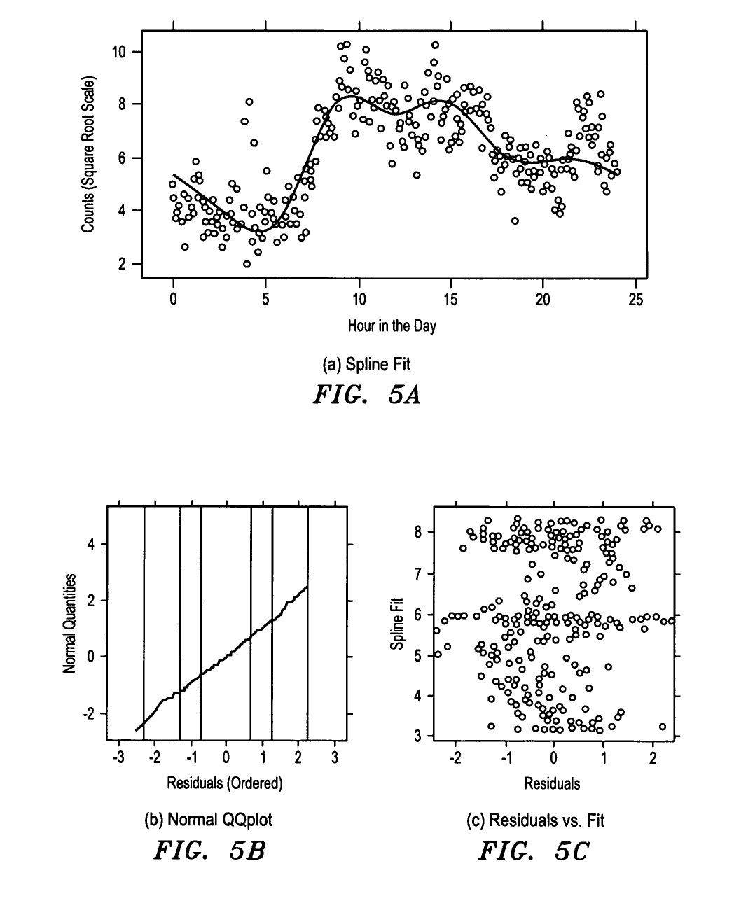

FIGS. 4 and 5A-C demonstrate the exemplary proposed spline model for the first day of the number of attempted calls shown in FIG. 5.

FIG. 5A shows the exemplary fit for the square root of the number of attempted calls, using the same cyclical spline basis as shown in FIG. 4.

FIG. 5B shows the exemplary normal quantile-quantile plot of the residuals from the fit, where points form an approximate straight line indicating a good match between the data and the normal distribution.

FIG. 5C plots the exemplary residuals against exemplary fitted mean which reveals little dependency of the residual variance on the mean.

To accommodate the normal variations of the daily patterns in the monitored series y(t), the monitoring software and/or hardware in the BTS 105 models the day-to-day change of the spline parameters as a random walk process, i.e., the spline parameters at day c only depend on the spline parameters at day c-1 plus an independent and identically distributed (i.i.d.) white noise.

ã_{c}=ã_{c-1}+σ\tilde{ε}_{c}, \tilde{ε}_{c}˜N(0, I_{L}), (state equation) (4)

where σ>0 is unknown, \tilde{ε}_{c} is dependent of the measurement noise vector ñ_{c},in (3), and I_{L} is the L×L identity matrix. Two assumptions are made here. First, it is assumed that the spline parameters are uncorrelated (as seen in the identity matrix I_{L} in (4)). This is justified since the daily patterns are usually fairly smooth, which means the knots of the splines can be sparse. As a consequence, the spline basis has a wide support which makes the independence assumption appropriate. Second, it is assumed that the spline parameters change from day to day, but do not change during the day. This is appropriate since the spline basis has a local compact support.

Above, the baseline reference model for the monitored network time series y(t) is explained under the assumption that there are only daily patterns in y(t). Two approaches to incorporating the day-of-week effects in the baseline reference model are discussed below.

The first approach models the day-of-the-week differences using a simple additive effect, that is, the basic patterns are the same up to a constant. This is a very simple way to include the day-of-the week effect since at most one extra parameter per day will be introduced to the model.

For the cth daily cycle, let s=[c/7] be the week index corresponding to c. Let wₛ, be the vector of additive constant parameters representing distinct day-of-week differences in the week of day c. For example, if weekdays are the same and weekends are the same, but weekdays and weekends are different from each other, wₛ would be a vector of 2, representing the additive constants of a weekday and a weekend in the week of day c. The observation equation (3) can be modified as

$$g ( {Y}_{c} ) = {Dw}_{s} + A {\tilde{α}}_{c} + {v}^{\frac{1}{2}} {\tilde{n}}_{c} , \qquad ( 5 )$$

where D is the incidence matrix (of 0s and 1s) indicating whether a particular day-of-week effect is in effect. For the state changes regarding wₛ, similar to the daily effect, it is assumed wₛ does not change within the week, but has the following random walk model between weeks:

wₛ=wₛ₋₁+ψξ₁, (6)

where ψ²>0 is an unknown variance parameter and I is the identity matrix with the same dimension as wₛ.

Sometimes, a simple additive effect may not be sufficient to characterize the day-of-week differences. Accordingly, in the second approach to incorporating the day-of-week effects in the baseline reference model, alternative spline parameters are introduced for the distinct day-of-the-week patterns. A spline basis that satisfies the cyclical and smoothness constraints at the day-of-week boundaries is used. In the following, this is demonstrated using a case of a distinct weekday and weekend pattern. The generalization to arbitrary day-of-week patterns are straightforward.

Again let K be the number of knots for each day-of-the-week. A spline basis function spanning a weekday and weekend (e.g. Friday and Saturday) at 2K−1 grid points is derived as follows. First use the standard spline equation on equally spaced knots to obtain the original 2K−2+d spline basis of order d. Notice that the weekdays and weekends are joined together at the two ends, which implies that the new basis functions should be cyclic in the weekday and weekend cycle defined above. Therefore, the new basis function can be constructed by wrapping the original basis function in the weekday and weekend cycle, and thus making the new basis functions cyclical and smooth at the two ends.

### Online Fitting Using Kalman Filter

Above, the state-space model represented by equations (3) and (4) is expressed in terms of each daily cycle. However, for online monitoring purposes, it may be more appropriate that the monitoring software and/or hardware in the BTS 105 perform computations for each incoming data value rather than each daily cycle.

Accordingly, in step S210, online fitting is performed on parameters of the baseline model generated in step S205. Step S210 may be accomplished using a simplified form of the state-space model expressed above by equations (3) and (4), and a recursive online fitting algorithm using Kalman filters based on this simplified model. Step S210 will be discussed below with reference only to daily effects in the network statistics observed by BTS 105, as the extension to the more general case with the weekly effects is straightforward.

To facilitate the online recursive fitting of y(t), a modified version of the model represented by equations (3) and (4) is used where individual times t replace daily cycles. For any time t, let its cycle number c=[t/L], and let

zₜ=g(y(t)), aₜ=ã_{c}, (7)

aₜ=(t−cL+1)^{th} row of A,

σₜ=0 if t Mod L=0, and σ otherwise,

εₜ=tth component of \tilde{ε}_{c}, nₜ=z(t)−E(z(t)).

Then equations (3) and (4) imply the following model for y(t),

$$\{ \begin{matrix}{α}_{t} = {α}_{t - 1} + σ {∈}_{t} , & {∈}_{t} \sim N ( 0 , 1 ) , \\ {z}_{t} = {a}_{t} {α}_{t} + {v}^{\frac{1}{2}} nt , & {n}_{t} \sim N ( 0 , 1 ) ,\end{matrix} \qquad ( 8 )$$

where nₜ is independent of εₜ. Now the modified state space model (8) is the classical state space model represented by (1) and (2), where aₜ is the state variable, zₜ is the observation variable, and the white noise processes in the state and observation equations, εₜ and nₜ, are uncorrelated. The modified state space model (8) is distinguished from the state space model represented by equations (1) and (2) in that, instead of updating parameters of the state space model after each daily cycle, parameters of the modified state space model (8) can be updated after each time period t. For example, if the network time series under study is the numbers of connection attempts made to the BS 105, instead of waiting for complete each daily cycle to update parameters of the state space model, parameters of the modified state space model (8) are updated after every time interval t, where each time interval may be, for example, five minutes.

For the spline parameter aₜ, define its predictive posterior mean, and predictive posterior variance scaled by a factor of σ⁻², given the observations up to t−1 by

$$\{ \begin{matrix}{μ}_{t}^{*} = E ( {α}_{t} \vert {z}_{0} , … , {z}_{t - 1} ) , \\ {P}_{t}^{*} = {σ}^{- 2} Var ( {α}_{t} \vert {z}_{0} , … , {z}_{t - 1} ) ,\end{matrix} \qquad ( 9 )$$

Likewise, define its posterior mean, and posterior variance scaled by σ⁻², given the observations up to t by

$$\{ \begin{matrix}{μ}_{t} = E ( {α}_{t} \vert {z}_{0} , … , {z}_{t - 1} ) , \\ {P}_{t} = {σ}^{- 2} Var ( {α}_{t} \vert {z}_{0} , … , {z}_{t - 1} ) ,\end{matrix} \qquad ( 10 )$$

The predictive conditional joint distribution of (aₜ, zₜ)′|z₀, . . . , zₜ₋₁, is distributed as

$$N [ ( \begin{matrix}{μ}_{t}^{*} \\ {a}_{t} {μ}_{t}^{*}\end{matrix} ) , ( \begin{matrix}{σ}^{2} {P}_{t}^{*} & {σ}^{2} {P}_{t}^{*} {a}_{t}^{′} \\ {σ}^{2} {a}_{t} {P}_{t}^{*} & {σ}^{2} {a}_{t} {P}_{t}^{*} {a}_{t}^{′} + v\end{matrix} ) ] \qquad ( 11 )$$

For a given value of σ² and v, iterative updating of μ*ₜ, P* ₜ, μₜ, and Pₜ can be accomplished by

$$\{ \begin{matrix}{P}_{t}^{*} = Pt - 1 + Σ t , \\ {μ}_{t}^{*} = {μ}_{t - 1 ,} \\ {( {P}_{t} )}^{- 1} = {( {P}_{t}^{*} )}^{- 1} + {σ}^{2} {v}^{- 1} {a}_{t}^{′} {a}_{t} \\ {μ}_{t} = {σ}^{2} {P}_{t} [ {a}_{t}^{′} {z}_{t} + {{σ}^{- 2} ( {P}_{t}^{*} )}^{- 1} {μ}_{t}^{*} ] .\end{matrix} \qquad ( 12 )$$

The update will start with a specified μ*₀, P*₀, which is the same as assuming a prior distribution of N (μ*₀, P*₀) on π(a₀).

The online recursive update equations (12) are based on the well-known Kalman Filter algorithm, which is used for estimating the state of a dynamic control system.

Furthermore, given the observations up to t−1, i.e., z₀, . . . zₜ₋₁, let z*, be the forecasting (predictive) value of zₜ, and let rₜ be the forecasting error. That is,

z*ₜ=aₜμ*ₜ

r*ₜ=zₜ−z*ₜ (13)

It is well-known from the theory of Gaussian processes that the forecasting errors are independently distributed, and from (11),

r*ₜ˜N(0, σ²aₜP*ₜaₜ′+v). (14)

The forecasting errors will be discussed further in conjunction with the online monitoring algorithm.

The online recursive fitting process discussed above relies on appropriate specifications of the hyper-parameters σ² and v. For example, consider the two extreme cases of σ². At one extreme, σ² is very large which implies the daily patterns have wide fluctuations. At the other extreme, σ² is zero which implies a fixed daily pattern. Obviously, these two extreme cases suggest very different baseline models. Care must also be taken to select an appropriate value for v, since v represents the noise level of the observed data g(yₜ). A data driven method of estimating σ² and v will now be discussed.

Let π(σ², v) be a prior distribution of σ², v. It is well recognized that the posterior density of (σ², v) given observations to t is a complex function, and cannot be easily optimized. A computationally cheap iterative approach to update the hyper-parameters (σ², v) is discussed below.

First, the values of σ², v may be initialized using some training data from the very beginning cycles so that the posterior density is not difficult to optimize. Suppose the first two daily cycles Y₀, Y₁ for training. Let

$$\begin{matrix}W = ( \begin{matrix}{μ}_{0}^{*} \\ {Y}_{0} \\ {Y}_{1}\end{matrix} ) , B = ( \begin{matrix}I \\ A \\ A\end{matrix} ) , \\ and & ( 15 ) \\ Q = ( \begin{matrix}{P}_{0}^{*} & 0 & 0 \\ 0 & vI & 0 \\ 0 & 0 & {σ}^{2} A \tilde{Σ} {A}^{′} + vI\end{matrix} ) & ( 16 )\end{matrix}$$

where I is the identity matrix. It is easy to show that the posterior density of [σ² , v, a₀) reduces to

$$f ( {σ}^{2} , v , {α}_{0} \vert {Y}_{0} , {Y}_{1} ) ∝ π ( {σ}^{2} , v ) {\vert {W}^{′} {Q}^{- 1} W - {W}^{′} {Q}^{- 1} {B ( {B}^{′} {Q}^{- 1} B )}^{- 1} {B}^{′} {Q}^{- 1} W \vert}^{- \frac{1}{2}} .$$

Now the derivative can be explicitly computed, and a second-order optimization method can be used to find optimal or preferred values of (σ², v). Estimates of (σ², v) can be updated based on newer data using, for example, a method of moments technique. Note from (11), the forecasting error r*ₜ has a variance σ²aₜP*ₜaₜ′+v. Also note that under the linear regression model for the cth cycle, g(Y_{c})=Aã_{c}+ñ_{c}, the sums of squares of residuals, Y′_{c}(I−A(A′A)⁻¹A)⁻¹Y_{c}, have the property that

E(Y′_{c}(I−A(A′A)⁻¹A)⁻¹Y_{c})=(L−K)v. (17)

Therefore, the simple moment updates of σ² and v can be derived by summing up values of (r*ₜ)² in a cycle and using (17).

Returning to FIG. 2, once online parameter fitting is complete in step S210 for the base line model generated in step S205, a new data value is observed by the BS 105 in step S215. Once the new data value is observed in step S215, the parameters of the modified state space model of Equation (8) are updated. Next, in steps S220 and S225, the forecast value z*ₜ and the forecast error r*ₜ are generated according to equation (13). In Step S230, an online monitoring scheme, which uses the log likelihood ratio of the forecasting errors r*ₜ, is employed to detect abnormalities in the behavior of the network time series y(t) being observed by the BS 105. After step S230, once another data value is observed in step S215, steps S220-S230 are completed again. Online monitoring schemes which may be used to perform step S230 are discussed in greater detail below.

### Online Monitoring Based on Forecasting Errors

Online schemes for monitoring the departure of the network time series y(t) from the modified state space model expressed above with reference to (8) will now be discussed. The following online monitoring schemes use statistical change detection and are developed based on the forecasting errors r*ₜ defined in (13).

In the discussion below, it is assumed that y(t) follows the modified state space model (8), where there is no day-of-week effect and the observational noise process is white noise. The extensions to include day-of-week effect are straightforward.

Let us consider the following change model for the monitored series y(t):

$$\{ \begin{matrix}{α}_{t} = {α}_{t - 1} + σ {∈}_{t} , & {∈}_{c} \sim N ( 0 , {Σ}_{t} ) , \\ g ( {y}_{t} ) = I ( t > {t}_{0} ) {C}_{0} ( t ) + {a}_{t} {α}_{t} + {v}^{\frac{1}{2}} {n}_{t} , & {n}_{t} \sim N ( 0 , 1 ) ,\end{matrix} \qquad ( 18 )$$

where I(·) is the indicating function, C₀(t) is a known function representing the magnitude of change, and t₀ is an unknown change point. Comparing to the modified state space model in (8), the only difference here is that an additive term I(t>t₀)C₀(t) is introduced to the observation equation.

Due to the Gaussian property, the forecasting residual r*ₜ can be written as a linear function of z₁, . . . , zₜ₋₁, zₜ, i.e.,

$${r}_{t}^{*} = {\sum }_{j = 0}^{t} {q}_{j , t} {z}_{j} ,$$

With q_{t,t}=1. Define

Qₜ≡(q_{0,t}, q_{1,t}, q_{2,t}, . . . , q_{t-1,t}, 1 ( 19)

and

vₜ=σ²aₜP*ₜa′ₜ+v. (20)

Now when t<t₀, the forecasting error r*ₜ follows the distribution in (13), i.e.,

Model H₀: r*ₜ˜N(0, vₜ) (21)

but when t≧t₀, from (18), the forecasting residual r*ₜ follows

Model H₁: r*ₜ˜N(Q′ₜC₁(t), vₜ, (22)

where C₁(t)is the vector representing the pointwise product of C₀(t) and I(t>t₀). It is clear now that even if C₁(t) is a step function, meaning the process g(y(t)) experiences a level shift after to, the expected change magnitude on the forecasting errors Q′ₜC₁(t)is not a step function, but rather has a dynamic profile.

H₀ is a no-change model which may represent a null hypothesis with respect to a log-likelihood ratio of r*ₜ while H₁ is a change model which may represent an alternative hypothesis with respect to a log-likelihood ratio of r*ₜ. Now for t≧t₀ the log-likelihood ratio of r*, under the model H₁ against H₀ can be conveniently calculated as:

$$\begin{matrix}{l}_{t} {,}_{{t}_{0}} = {v}_{t}^{- 1} {Q}_{t}^{′} {C}_{1} ( t ) ( {r}_{t}^{*} - \frac{1}{2} {Q}_{t}^{′} {C}_{1} ( t ) ) . \\ Let & ( 23 ) \\ {L}_{t} = {max}_{1 \leq j \leq t} {\sum }_{i = j}^{t} {l}_{i , j} & ( 24 )\end{matrix}$$

Lₜ can be computed in a recursive fashion, and the optimal control scheme would signal when |Lₜ| exceeds a threshold h_{c}.

Alternatively, a CUMSUM like control scheme, which is similar to the optimal scheme in (24), can be used by substituting lₜ,ₜ_{₀} by lₜ, tₜ for t>t₀. Let

$${l}_{t} {,}_{{t}_{0}} = {v}_{t}^{- 1} {C}_{1} ( t ) ( {r}_{t}^{*} - \frac{1}{2} {C}_{1} ( t ) ) , \qquad ( 25 )$$

and define

\tilde{L}ₜ=max(Lₜ₋₁+\tilde{l}ₜ,0). (26)

The CUMSUM scheme would signal the series as out of normal behavior if

|\tilde{L}ₜ|>h_{c} (27)

for some threshold value h_{c}.

Accordingly, if in step S230, the base station 105 determines that |\tilde{L}ₜ|>h_{c}, the base station 105 will determine that network time series y(t) has departed from normal behavior.

The value of h_{c}, is chosen such that the mean time between false alarms (also known as the Average Run Length (ARL)) is larger than a specified value, using Monte-Carlo simulations.

Design choices of C₀(t)will now be discussed. Assume C₀(t) has the following form:

C₀(t)=γc₀(t), (28)

where γ is a prescribed multiplicative factor, and c₀(t) is a known change proffile. c₀(t) often takes one of two forms in the provided embodiments.

For simplicity, again it is assumed that y(t) has only daily cycles but no day-of-week patterns. The first usual form is a constant form, i.e., c₀(t)≡1. The second usual form assumes c₀(t) is a cyclical function minicking the baseline model itself, and thus C₀(t) represents a multiplicative change from the expected baseline behavior. In this case, c₀(t) may be derived from the early training data and can be dynamically updated based on the newer observations.

Though the exemplary method for monitoring and detecting abnormalities data of a network stream illustrated in FIG. 2 is described above with reference to the base station 105 where the network time series y(t) represents a number of connection attempts made to the BS 105 over given time intervals, the method is not limited to this implementation. The network series y(t) can represent any type of network data that is Gaussian or can be transformed, for example through a function g(·), to be Gaussian. For example, embodiments of the method can be used with the RNC 101 where the network time series y(t) represents average network latencies of wireless calls handled by the RNC 101 over given time intervals. Other examples of data that can be represented by network time series y(t) include IP traffic in terms of packets or bytes, or a number of active mobile devices handled by an RNC or a base station.

Once abnormal behavior is detected in a network series y(t), the resulting alarm may trigger corrective action to be taken with respect to the network. The corrective action may be executed by, for example, a network operator monitoring the network, or an automated system associated with the network. For instance, if an abnormally high average network latency is detected at RNC 101, a network operator may be notified so that the network operator may redistribute mobile traffic to other RNCs in order to reduce the load on RNC 101. As another example, if an abnormally high amount of IP traffic is detected, a network operator can be notified so that the network operator may investigate the IP traffic in order to determine whether a denial-of-service (DOS) attack is underway. Experimental Studies

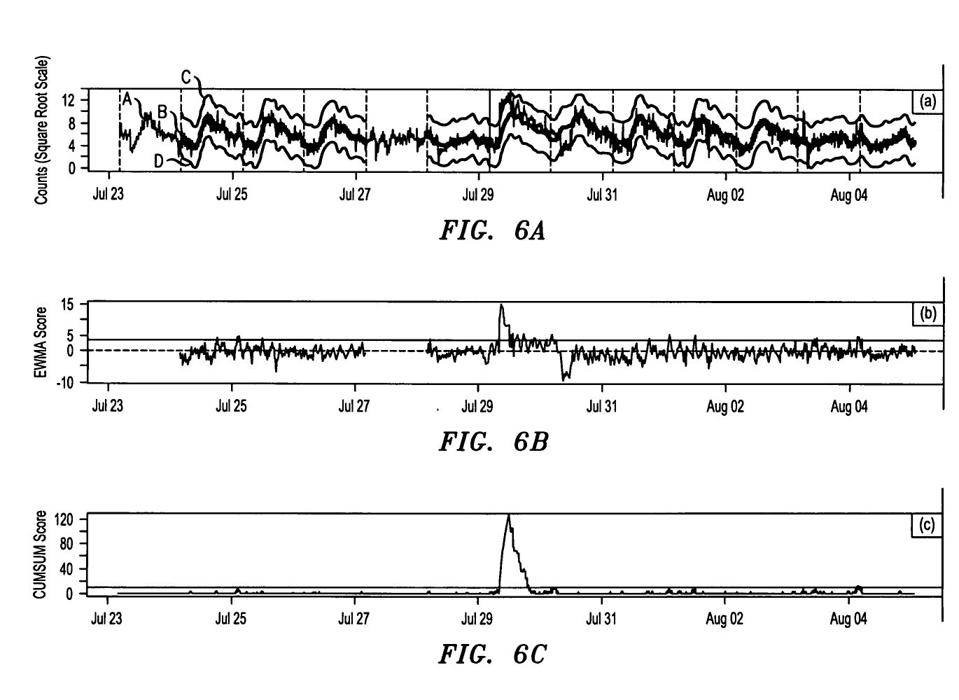

FIGS. 6A-C illustrate the process of detecting abnormalities in step S230 illustrated in FIG. 2 using exemplary experimental results based on data examples from a Wireless EVDO network. The monitoring data used in FIGS. 6A-C was collected using CELNET explorer, a non-intrusive tool designed with advanced measurement, analysis and optimization capabilities far 3Glx, EV-DO, and UMTS networks. The data used in FIGS. 6A-C is sanitized by multiplication with an unspecified constant.

FIG. 6A illustrates an exemplary graph showing the time series plot of the number of attempted connections for a base station in the EVDO network, in square root scale. FIG. 6A corresponds to the exemplary graph illustrated in FIG. 3. In the exemplary graph illustrated in FIG. 6A, time series data is observed at every 5 minutes over a two week period. In FIG. 6A, the time series plot is illustrated as the thin, middle line labeled A. As is demonstrated in FIGS. 5A-5C, the square root transformation equalizes the variance of the counts, and the transformed data is approximated by a Gaussian distribution. In the illustrations, the daily cycle is evident as well as the weekday and weekend differences. However, in this case, the weekday and weekend differences cannot be simply summarized by an additive effect as is discussed above with reference to equation (5).

Therefore, a separate set of spline parameters may be used for modeling weekdays and weekends, where the knots are chosen at every 2 hours of the weekday and weekend. Knots may be chosen at other time intervals. The first weekday and weekend are used for training, and the fit does not show notable difference if knots are increased to every hour. FIG. 6A shows the resulting fit using the Kalman filtering algorithm discussed above with reference to step S210. Referring to FIG. 6A, the one step ahead forecast prediction of the square root counts from the baseline model are shown as the smooth, thick line, B, overlaid on top of the time series plot A. The point-wise predictive confidence intervals for quantiles 0.0001 and 0.9999 are shown as the lines C and D above and below the time series plot A. Because the number of attempted connections is time varying, a multiplicative change model, discussed above with reference to equations 18 and 28, is considered with a change profile c₀(t) being the expected daily pattern derived from the first cycle of weekday and weekend, and a multiplicative factor γ, 1.3 in the illustrated example.

FIG. 6C illustrates experimental results using the likelihood ratio based CUMSUM control scheme, discussed above with reference to equations 25, 26 and 27. In the CUMSUM scheme used to create the results illustrated in FIG. 6C, the alarm threshold is determined based on Monte-Carlo simulations from a state space model with the same estimated parameters, with an average mean delay between false alarms set at one month. As FIG. 6C illustrates, the CUMSUM control scheme identifies one most visible alarm around the morning of July 29. The alarm is indicated in FIG. 6C by the plotted results exceeding the alarm threshold on the morning of July 29. The presence of an alarm on the morning of July 29 as illustrated in FIG. 6C corresponds to an abnormality being detected in step S230 of the method illustrated in FIG. 2.

For comparison, experimental results were also collected using a monitoring scheme that is based on exponentially weighted moving averages (EWMA) of standardized forecasting residuals. These results are illustrated in FIG. 6B. A weight of 0.25 and an alarming threshold at 3.68 are used in the EWMA scheme used to create the results illustrated in FIG. 6B. Referring to FIGS. 6B and 6C, the CUMSUM scheme results show fewer false alarms when compared to EWMA scheme results while, at the same time, both schemes detected the alarm on the morning of July 29 at around the same time.

Embodiments of the invention being thus described, it will be obvious that embodiments may be varied in many ways. Such variations are not to be regarded as a departure from the invention, and all such modifications are intended to be included within the scope of the invention.

What is claimed:

1. A method of modeling and detecting abnormalities in data of a network stream, the method comprising:
generating at a network device, a statistical model based on observed data, the observed data being associated with the network device; and
for each newly observed data value
performing online parameter fitting on parameters of the statistical model,
generating a forecast value based on the statistical model, the forecast value being a prediction of a next observed data value,
generating a forecasting error based on the forecast value and the newly observed data value, and
determining whether the data of the network stream is abnormal based on a log likelihood ratio of the forecasting error and a threshold value.

2. The method of claim 1, wherein the network device is a base station.

3. The method of claim 1, wherein the observed data value is a number of attempted connections from a plurality of mobile devices to the network device over a reference time period.

4. The method of claim 1, wherein the network device is a radio network controller (RNC).

5. The method of claim 1, wherein the observed data value is an average network latency of wireless calls handled by the network device over a reference time period.

6. The method of claim 1, wherein upon receipt of each newly observed data value, parameters of the state equation are updated.

7. The method of claim 1 wherein generating the statistical model based on observed data includes applying a transformation to the observed data such that the observed data is made Gaussian.

8. The method of claim 1, wherein the online parameter fitting is performed using Kalman filters.

9. The method of claim 1, wherein determining whether data of the network stream is abnormal includes
determining a value of the log-likelihood ratio of the forecasting error and previously generated forecasting errors using a no-change model under a null hypothesis and a change model under an alternative hypothesis,
comparing the value of the log-likelihood ratio to the threshold value, and determining that data of the network stream is abnormal when the value of the log-likelihood ratio exceeds the threshold value.

10. The method of claim 9, wherein the threshold value is chosen such that a mean time between false alarms is greater than a reference value, a false alarm being an occurrence where the value of log-likelihood ratio test exceeds the threshold value and the data of the network stream is not abnormal.

11. The method of claim 1, further comprising:
taking corrective action with respect to the network, if abnormal behavior is detected in the data of the network stream.

12. An apparatus for modeling and detecting abnormalities in data of a network stream, the apparatus comprising:
a memory for storing parameters and data values associated with the network stream; and
a processor coupled to the memory and configured to control operations associated with modeling and detecting abnormalities in the data of the network stream including
generating a statistical model based on observed data, the observed data being associated with the apparatus; and
for each newly observed data value
performing online parameter fitting on parameters of the statistical model,
generating a forecast value based on the statistical model, the forecast value being a prediction of a next observed data value,
generating a forecasting error based on the forecast value and the newly observed data value, and
determining whether the data of the network stream is abnormal based on a log likelihood ratio of the forecasting error and a threshold value.

13. The apparatus of claim 12, wherein the apparatus is a base station.

14. The apparatus of claim 12, wherein the observed data value is a number of attempted connections from a plurality of mobile devices to the apparatus over a reference time period.

15. The apparatus of claim 12, wherein the apparatus is a radio network controller (RNC).

16. The apparatus of claim 12, wherein the observed data value is an average network latency of wireless calls handled by the apparatus over a reference time period.

17. The apparatus of claim 12, wherein the processor is configured to control updating of parameters of the state equation upon receipt of each newly observed data value.

18. The apparatus of claim 12, wherein the processor is configured so that the operation of generating the statistical model based on observed data includes applying a transformation to the observed data such that the observed data is made Gaussian.

19. The apparatus of claim 12, wherein the processor is configured so that the operation of performing online parameter fitting uses Kalman filters.

20. The apparatus of claim 12, wherein the processor is configured so that the operation of determining whether data of the network stream is abnormal includes
determining a value of the log-likelihood ratio of the forecasting error and previously generated forecasting errors using a no-change model under a null hypothesis and a change model under an alternative hypothesis,
comparing the value of the log-likelihood ratio to the threshold value, and determining that data of the network stream is abnormal when the value of the log-likelihood ratio exceeds the threshold value.
